(19) United States
(12) Patent Application Publication
(10) Pub. No.: US 2004/0009378 A1
(43) Pub. Date: Jan. 15, 2004

(54) Gasification of lignocellulose for production of electricity from fuel cells

(76) Inventor: Gene E. Lightner, Federal way, WA (US)

Correspondence Address: Gene E. Lightner, 706 SW 296th St., Federal Way, WA, 98023-3549, US

(21) Appl. No.: 10/191,896

(22) Filed: Jul. 9, 2002

(51) Int. Cl. H01M 8/06

(52) U.S. Cl. 429/17; 429/20

(57) ABSTRACT

Production of electricity originates by providing a supply of lignocellulose and a vessel for gasification and subjecting the lignocellulose to gasification to afford access to fuel cells; thereupon conveying products of gasification to a stack of fuel cells and providing air to the fuel cells for reaction of oxygen within air, hence generating direct current and exothermic heat transferred to the gasification vessel as endothermic heat. Resulting direct current is converted to alternating current to supply alternating current to a power main. Residue, remaining from gasification, is subjected to disposal. Thereby direct current from a stack of fuel cells is generated by gasification of lignocellulose.

### BACKGROUND OF THE INVENTION

Lignocellulose is of limitless supply by photosynthesis from energy from the sun. Gasification of biomass and cellulosic materials are the topics within U.S. Pat. No. 5,666,890 and U.S. Pat. No. 4,699,632. Both gasification procedures depend on a fluidized bed to produce combustible gases. Gasification products, carbon monoxide, water and volatile organic compounds are often subjected to reforming and steam shifting to create hydrogen and carbon dioxide. These procedures can be accomplished by high temperature fuel cells. High temperature fuel cells react with oxygen within air simultaneously reforming volatile organic compounds and accomplishing steam shifting to create hydrogen. The hydrogen reacts within the fuel cells to create direct current and water. Various descriptions of internal reforming, employing stacks of fuel cells operating at high temperature are found, for example, within U.S. Pat. No. 6,344,289, U.S. Pat. No. 6,200,696 and U.S. Pat. No. 6,110,614, accomplish reforming of hydrocarbon fuel to form hydrogen without utilizing a catalyst. Exothermic heat generated by the reaction of hydrogen and oxygen can be used for gasification of solid lignocellulose material.

It is therefore an object of this invention to obviate many of the limitations or disadvantages of the prior art.

A principal object of this invention is to produce electrical power by gasification of lignocellulose material

A distinct object of this invention is to employ a stack of fuel cells, operating at high temperature to generate electrical power

A further object of this invention is to achieve internal reforming of volatile organic compounds within fuel cells.

Another object of this invention is to furnish exothermic thermal energy, generated within fuel cells, for gasification of lignocellulose material, requiring endothermic heat.

Furthermore a fundamental object of this invention is gasification of lignocellulose material.

Still another object of this invention is to convert direct current, generated by fuel cells, to alternating current of the same electrical phase as the alternating current within a power grid. With the above and other objects in view, this invention relates to the novel features and alternatives and combinations presently described in the brief description of the invention.

### APPLIED BACKGROUND OF THE INVENTION

A practice applied within the present invention, is gasification of lignocellulose material, similar to biomass gasification, commonly acknowledged. High temperature fuel cells that accomplish this are, for example, molten carbonate fuel cells and solid oxide fuel cells. High temperature fuel cells reacting with oxygen within air, simultaneously reform volatile organic compounds and accomplish steam shifting, by water vapor derived from gasification. Lignocellulose gasification, producing volatile organic compounds and carbon monoxide, transmitted to fuel cells, will produce hydrogen to react with oxygen in air to form water within fuel cells. Water vapor is reacted with carbon monoxide to shift carbon monoxide to carbon dioxide and form hydrogen, within the reversible chemical formula, H₂ O+CO [symbol] CO₂+H₂ provided in Chemical Process Industries, second edition, authored by R. N. Shreve, page 121. At high temperatures, found within fuel cells, the reaction is accelerated and the hydrogen which upon reacting within fuel cells reduces hydrogen in the equilibrium to facilitate shifting of carbon monoxide existing within gasification of lignocellulose. Accordingly a catalyst for shifting is unnecessary. Fuel cells form direct current and exothermic heat. Exothermic heat is then employed for lignocellulose gasification, which requires endothermic heat. Waste heat, containing water vapor, is heated by air to condense water and create waste heated air for application to dehydrate lignocellulose for gasification. A stack of fuel cells selected from the group consisting of molten carbonate fuel cells, solid oxide fuel cells or a combination thereof is commonly employed. Direct current formed from fuel cells is converted to alternating current. This operation is performed by well known equipment referred to as an AC/DC inverter. Alternating current, thus created, is transformed to increase the voltage level with a transformer for subsequent access to a power grid. Electrical phase of the alternating current must match that within the power grid, for compatibility.

### BRIEF DESCRIPTION OF THE INVENTION

The present invention in its broadest aspect, establishes a method to produce electricity from fuel cells powered by gasification of a lignocellulose which comprises: providing a supply of lignocellulose and a vessel for gasification and providing a stack of fuel cells and subjecting the lignocellulose to gasification within the vessel. By conveying products of gasification to the stack of fuel cells, and providing air to the stack of fuel cells for reaction of oxygen within the air, and conducting exothermic heat generated from the stack of fuel cells to the vessel to provide endothermic heat for gasification of the lignocellulose. Residue remaining from gasification is disposed off. Generating direct current from the stack of fuel cells is achieved. Thereby direct current from a stack of fuel cells is generated by gasification of lignocellulose.

Characteristics of the invention include:

Lignocellulose, substantially dehydrated, is subjected to gasification to provide products of gasification.

Products of gasification are conveyed to a stack of fuel cells operated at a predetermined temperature from about 500 to about 1000 degrees Celsius.

The stack of fuel cells is supplied with air to generate direct current and water.

The fuel cells generate exothermic heat and transports heat by thermal conduction to the vessel for gasification, maintained at a temperature of about 500 to about 1000 degrees Celsius.

The direct current is transformed to alternating current which is utilized within a transformer to produce alternating current with the same electrical phase and voltage compatible with a power grid.

The stack of fuel cells is selected from the group consisting of molten carbonate fuel cells, solid oxide fuel cells or a combination thereof.

The method is performed in a continuous manner.

The fuel cells are stacked in layers separated by metal layers.

Organic compounds are converted within fuel cells to form hydrogen and carbon dioxide.

The vessel for gasification is pressurized from about 5 atmospheres to about 10 atmospheres.

The supply of lignocellulose is subjected to pyrolysis

Endothermic heat for gasification of lignocellulose, is supplemented by electrical heat.

Gasification contains volatile organic compounds.

Lignocellulose is subjected to gasification within a fluidized bed reactor.

### BRIEF DESCRIPTION OF THE DRAWINGS

Features that are considered characteristic of this invention are set forth in the appended claims. This invention, however, both as to its origination and method of operations as well as additional advantages will best be understood from the following description when read in conjunction with the accompanying drawings in which:

FIG. 1 is a flow sheet denoting the invention as set forth in the appended claims.

FIG. 2 is a flow sheet denoting a method to add electrical heat for gasification of a lignocellulose

FIG. 3 is a flow sheet denoting a method to convert direct current to alternating current.

### DETAILED DESCRIPTION OF THE PREFERRED EMBODIMENT

In the preferred embodiment of the present invention production of direct current from a stack of fuel cells by gasification of a lignocellulose is accomplished. These procedures are operated at a predetermined temperature from about 500 to about 1000 degrees Celsius

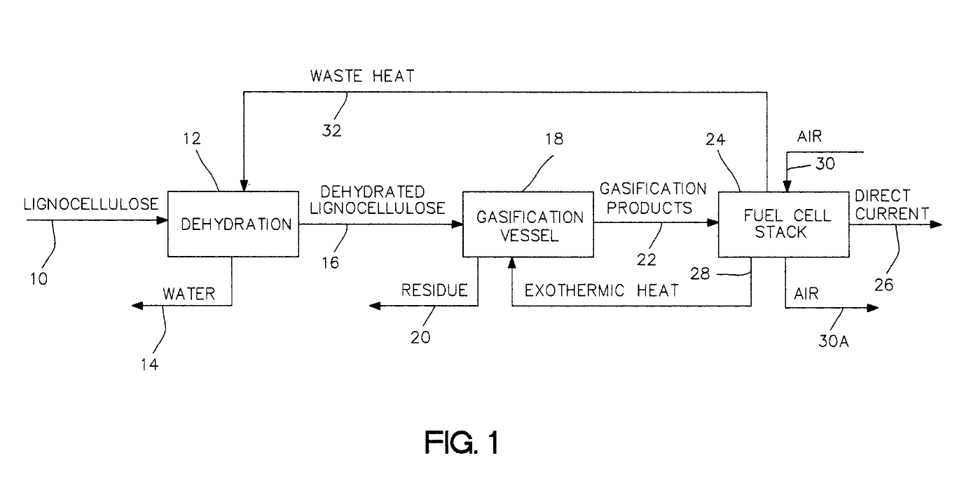

The flow diagram of FIG. 1 illustrates the general preferred embodiment of the present invention. In the diagram, rectangles represent stages, operations or functions of the present invention and not necessarily separate components. Arrows indicate direction of flow in the method. The method portrayed in FIG. 1 will take place from lignocellulose, subject to gasification, supplied to a fuel cell stack to result in formation of direct current.

Referring to FIG. 1, lignocellulose 10 is conveyed to dehydration stage 12 to create water 14 and dehydrated lignocellulose 16. Dehydrated lignocellulose 16, is subjected to gasification vessel 18 to create gasification products 22 and residue 20 for disposal and to supply gasification products 22 to fuel cell stack 24 which generates direct current 26 and creates exothermic heat 28. Exothermic heat 28 is conducted to gasification vessel 18 for endothermic gasification. Air 30, is provided to furnish oxygen to fuel cell stack 24, and creates oxygen depleted air 30A from consumed oxygen. Waste heat 32 is delivered to dehydration stage 12 to form water 14 and dehydrated lignocellulose 16. Air 30, is commonly heated from spent air 30A. Waste heat 32, containing water vapor, is heated by air to condense water and create waste heated air for application to dehydrate lignocellulose. Lignocellulose is usually selected from the group consisting of woody material, waste paper and MSW including an individual or combination thereof.

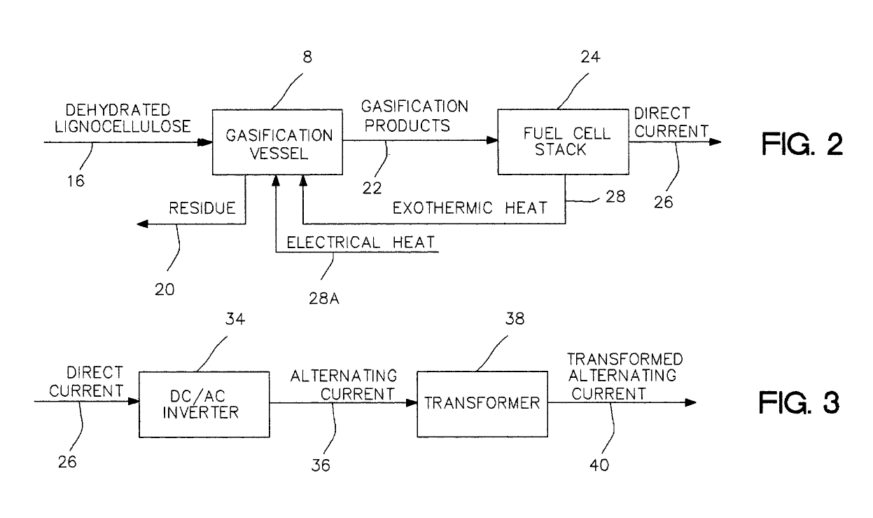

Referring to FIG. 2, dehydrated lignocellulose 16 is subjected to gasification vessel 18 to create residue 20 for disposal and gasification products 22 to supply fuel cell stack 24. Fuel cell stack 24 generates direct current 26 and creates exothermic heat 28. Exothermic heat 28 is conducted to gasification vessel 18 for endothermic gasification. Electrical heat 28A, as required, is added to the gasification vessel 18 to add to exothermic heat 28 required for endothermic gasification. Air, required within the fuel cell stack 24, was determined to be immaterial within FIG. 2. Disposing of remaining residue is executed.

Referring to FIG. 3, direct current 26 from fuel stack 24 is inverted from direct current to alternating current by DC/AC inverter 34 to create alternating current 36 to be transferred to transformer 38 to provide transformed alternating current 40. Transformed alternating current 40, in electrical phase with a power grid, is admitted to the power grid.

What is claimed is:

1. A method to produce electricity from fuel cells powered by gasification of a lignocellulose, which comprises:
providing a supply of lignocellulose
providing a vessel for gasification
providing a stack of fuel cells
subjecting said lignocellulose to gasification within said vessel, and
conveying products of gasification to said stack of fuel cells, and
providing air to said stack of fuel cells for reaction of oxygen within said air, and
conducting exothermic heat generated from said stack of fuel cells to said vessel to provide
endothermic heat for gasification of said lignocellulose, and
generating direct current from said stack of fuel cells, and
disposing residue remaining from gasification thereby direct current from a stack of fuel cells is generated by gasification of lignocellulose.

2. The method of claim 1 wherein said direct current is transformed to alternating current.

3. The method of claim 2 wherein the alternating current is transformed within a transformer to produce alternating current of adequate voltage for a power grid.

4. The method of claim 2 wherein the alternating current is of the same electrical phase as the power grid.

5. The method of claim 1 wherein said stack of fuel cells is selected from the group consisting of molten carbonate fuel cells, solid oxide fuel cells or a combination thereof.

6. The method of claim 1 wherein the method is continuous.

7. The method of claim 1 wherein said vessel for gasification is maintained at a temperature of about 500 to about 1000 degrees Celsius

8. The method of claim 1 wherein said fuel cells are operated at a predetermined temperature from about 500 to about 1000 degrees Celsius

9. The method of claim 1 wherein said fuel cells generate exothermic heat and transports heat by thermal conduction to said vessel.

10. The method of claim 9 wherein the fuel cells transports exothermic heat by a metal.

11. The method of claim 1 wherein said fuel cells are stacked in layers separated by metal layers.

12. The method of claim 1 wherein said vessel for gasification is pressurized from about 5 atmospheres to about 10 atmospheres.

13. The method of claim 1 wherein said endothermic heat for gasification of said lignocellulose, is supplemented by electrical heat.

14. The method of claim 1 wherein said lignocellulose is dehydrated prior to gasification.

15. The method of claim 1 wherein said products of gasification contain water vapor.

16. The method of claim 1 wherein said lignocellulose is selected from the group consisting of woody material, waste paper and MSW including an individual or combination thereof.

17. The method of claim 1 wherein said supply of lignocellulose is subjected to pyrolysis.

18. The method of claim 1 wherein said lignocellulose, subjected to gasification, contains volatile organic compounds.

19. The method of claim 18 wherein the volatile organic compounds are converted within said fuel cells to form hydrogen.

20. The method of claim 1 wherein said lignocellulose is subjected to gasification within a fuidized bed reactor.
